(19) United States
(12) Patent Application Publication
(10) Pub. No.: US 2026/0160216 A1
(43) Pub. Date: Jun. 11, 2026

(54) INTERNAL COMBUSTION ENGINE

(71) Applicant: TOYOTA JIDOSHA KABUSHIKI KAISHA, Toyota-shi (JP)

(72) Inventors: Ryoji ABE, Okazaki-shi (JP); Toshihiro ISHIKAWA, Toyota-shi (JP); Tomoyuki UCHIYAMA, Toyota-shi (JP); Eiji SANO, Nagoya-shi (JP)

(73) Assignee: TOYOTA JIDOSHA KABUSHIKI KAISHA, Toyota-shi (JP)

(21) Appl. No.: 19/299,518

(22) Filed: Aug. 14, 2025

(30) Foreign Application Priority Data
Dec. 11, 2024 (JP) 2024-216918

(51) Int. Cl. F02D 41/30; F02M 61/14

(52) U.S. Cl. CPC F02D 41/3094; F02M 61/14

(57) ABSTRACT

An internal combustion engine includes a first injection valve configured to inject a fuel into an intake port of the internal combustion engine, a second injection valve configured to inject a fuel into a cylinder of the internal combustion engine, and a controller configured to control an in-cylinder injection ratio that is a ratio of an in-cylinder injection amount to a total amount of a port injection amount and the in-cylinder injection amount. The controller of the internal combustion engine is configured to increase the in-cylinder injection ratio in response to an integrated value of time during which the internal combustion engine has been operated in a target operation state reaching or exceeding a threshold, the target operation state being an operation state in which the in-cylinder injection ratio is 0% in a low-load low-speed operation region that is predetermined.

### CROSS-REFERENCE TO RELATED APPLICATION

This application claims priority to Japanese Patent Application No. 2024-216918 filed on Dec. 11, 2024. The disclosure of the above-identified application, including the specification, drawings, and claims, is incorporated by reference herein in its entirety.

### BACKGROUND

### 1. Technical Field

The present disclosure relates to an internal combustion engine.

### 2. Description of Related Art

An internal combustion engine including a port injection valve that injects a fuel into an intake port and an in-cylinder injection valve that directly injects the fuel into a cylinder is known. In such an internal combustion engine, a technique is known in which, in a case where the estimated amount of deposit accumulated on the in-cylinder injection valve is greater than an amount that is predetermined when fuel injection from the port injection valve is performed in an idle operation state, the fuel injection from the port injection valve is stopped and fuel injection from the in-cylinder injection valve is performed (see, for example, Japanese Unexamined Patent Application Publication No. 2012-149555 (JP 2012-149555 A)).

In addition, a technique is also known in which, when a deposit adhered to the back of a head of an intake valve needs to be cleaned, fuel injection from an in-cylinder injection valve is stopped and fuel injection from a port injection valve is performed (see, for example, Japanese Unexamined Patent Application Publication No. 2007-247425 (JP 2007-247425 A)).

In addition, a technique is known in which, in an operation state that is predetermined where a deposit tends to adhere to the back of a head of an intake valve, a part of the fuel injection amount to be supplied to the cylinder every cycle is injected from a port injection valve and the remaining part is injected from an in-cylinder injection valve (see, for example, Japanese Unexamined Patent Application Publication No. 2015-117661 (JP 2015-117661 A)).

In addition, a technique is also known in which, in a warm idle operation state, fuel injection from an in-cylinder injection valve is performed at a low pressure (see, for example, Japanese Unexamined Patent Application Publication No. 2007-009815 (JP 2007-009815 A)).

### SUMMARY

An object of the present disclosure is to provide a technique capable of suitably suppressing accumulation of a deposit derived from a fuel in an intake system of an internal combustion engine.

An aspect of the present disclosure is an internal combustion engine. For example, the internal combustion engine in that case includes
a first injection valve configured to inject a fuel into an intake port of the internal combustion engine,
a second injection valve configured to inject a fuel into a cylinder of the internal combustion engine, and
a controller configured to control an in-cylinder injection ratio that is a ratio of an in-cylinder injection amount to a total amount of a port injection amount and the in-cylinder injection amount, the port injection amount being a fuel injection amount of the first injection valve and the in-cylinder injection amount being a fuel injection amount of the second injection valve,
in which the controller is configured to increase the in-cylinder injection ratio in response to an integrated value of time during which the internal combustion engine has been operated in a target operation state reaching or exceeding a threshold, the target operation state being an operation state in which the in-cylinder injection ratio is 0% in a low-load low-speed operation region that is predetermined.

According to the present disclosure, it is possible to provide a technique capable of suitably suppressing accumulation of a deposit derived from a fuel in an intake system of an internal combustion engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a schematic configuration of a vehicle according to an embodiment;

FIG. 2 is a diagram schematically showing an example of a distribution map according to the embodiment;

FIG. 3 is a flowchart showing an example of a processing routine executed by an ECU according to the embodiment;

FIG. 4 is a diagram schematically showing an example of a schematic configuration of a vehicle according to Modification 1;

FIG. 5 is a flowchart showing an example of a processing routine executed by an ECU according to Modification 1; and

FIG. 6 is a flowchart showing an example of a processing routine executed by an ECU according to Modification 2.

### DETAILED DESCRIPTION OF EMBODIMENTS

In an internal combustion engine including a first injection valve that injects a fuel into an intake port and a second injection valve that injects the fuel into a cylinder, when operation is performed in a low-load low-speed operation region that is predetermined (for example, an idle operation region) in which an in-cylinder injection ratio (a ratio (percentage) of an in-cylinder injection amount to a total amount of a port injection amount and the in-cylinder injection amount, the port injection amount being a fuel injection amount of the first injection valve and the in-cylinder injection amount being a fuel injection amount of the second injection valve) is 0%, a part of the fuel injected from the first injection valve may be blown back from the cylinder into the intake port and adhere to an intake port wall surface or to a back surface of a head portion of an intake valve (a surface of the head portion on an intake port side). As a result of repeated intensive experiments and verifications conducted by the present inventors on such a phenomenon, it was found that, when a time during which the internal combustion engine is operated in an operation state where the in-cylinder injection ratio is 0% in the low-load low-speed operation region that is predetermined is long, a deposit derived from a fuel (hereinafter, may be referred to as an “adhesive fuel”) adhering to a portion may be generated and accumulated on the intake port wall surface or the back surface of the head portion of the intake valve, and a failure in closing the intake valve may occur due to peeling of the accumulated deposit from the intake port wall surface or the back surface of the head portion of the intake valve. Therefore, there is a demand for a measure for suppressing occurrence of such a problem.

An internal combustion engine according to the present disclosure has been made in order to solve the problem, and includes a controller configured to increase the in-cylinder injection ratio in accordance with an integrated value of time during which the internal combustion engine has been operated in a target operation state becomes equal to or greater than a threshold. The “target operation state” according to the present disclosure is an operation state in which the in-cylinder injection ratio is 0% in the low-load low-speed operation region that is predetermined. The “in-cylinder injection ratio” according to the present disclosure is a ratio (percentage) of the in-cylinder injection amount to the total amount of the port injection amount and the in-cylinder injection amount, the port injection amount being the fuel injection amount of the first injection valve and the in-cylinder injection amount being the fuel injection amount of the second injection valve. The “integrated value” according to the present disclosure may be, for example, an integrated value of time during which the internal combustion engine has been continuously operated in the target operation state. In another example, the “integrated value” according to the present disclosure may be an integrated value of time during which the internal combustion engine has been intermittently operated in the target operation state. In addition, the “threshold” according to the present disclosure may be, for example, a time shorter than a time expected to be required until an adhesive fuel changes to a deposit. In another example, the “threshold” according to the present disclosure may be a time during which an accumulation amount of deposit derived from the adhesive fuel is not expected to exceed an upper limit value. In the case, the upper limit value may be, for example, a deposit accumulation amount at which, when the deposit accumulation amount exceeds the upper limit value, an air amount satisfying a required torque cannot flow into the cylinder. In another example, the upper limit value may be a deposit accumulation amount at which the deposit is considered to easily peeled off from an intake port wall surface or a back surface of a head portion of an intake valve. The threshold as described above may be obtained in advance through one or both of experiments and simulations.

With the internal combustion engine according to the present disclosure, it is possible to prevent one or both of accumulation of a deposit derived from a fuel injected from the first injection valve on the intake port and the back surface of the head portion of the intake valve, and increase in an accumulation amount. In a case where a transition is made from a state where the in-cylinder injection ratio is 0% (a state where the second injection valve does not perform fuel injection) to a state where the in-cylinder injection ratio is larger than 0% (a state where the second injection valve performs fuel injection) in the low-load low-speed operation region, an operation sound generated by a pressurization operation of the supply pump and an opening and closing operation of the second injection valve occurs. Such an operation sound tends to be larger than an operation sound of the first injection valve. Therefore, when processing of increasing the in-cylinder injection ratio from 0% in the low-load low-speed operation region is frequently executed, there is a possibility that a passenger of the vehicle equipped with the internal combustion engine perceives an abnormal sound. On the other hand, with the internal combustion engine according to the present disclosure, since processing of increasing the in-cylinder injection ratio from 0% is not executed until the integrated value becomes equal to or greater than the threshold, it is possible to reduce an opportunity for the passenger to perceive an abnormal sound.

The “threshold” according to the present disclosure may be set according to at least one of an area where the vehicle has been lastly refueled, a time when the vehicle has been lastly refueled, or an outside air temperature. Here, the ease and difficulty of deposit accumulation may change according to one or both of a fuel property and the outside air temperature. The fuel property may change according to one or both of a refueling area and a refueling time. Therefore, by setting the threshold according to at least one of the area where the vehicle has been lastly refueled, the time when the vehicle has been lastly refueled, or the outside air temperature, it is possible to prevent accumulation of the deposit on the intake port and the back surface of the head portion of the intake valve while reducing an opportunity for a passenger to perceive an abnormal sound as much as possible.

In addition, in the internal combustion engine according to the present disclosure, in a case where a radiator fan is operated when the integrated value is less than the threshold and the operation state of the internal combustion engine is the target operation state, the controller may increase the in-cylinder injection ratio in accordance with the operation of the radiator fan. In a case where the radiator fan is operating, an operation sound of the supply pump and the second injection valve is likely to be drowned out by an operation sound of the radiator fan. Therefore, even in a case where the in-cylinder injection ratio is increased in accordance with the operation of the radiator fan, it is difficult for the passenger to perceive an abnormal sound. Therefore, in a case where the integrated value is less than the threshold, by increasing the in-cylinder injection ratio in accordance with the operation of the radiator fan, it is possible to more reliably prevent accumulation of the deposit while reducing an abnormal sound perceived by the passenger.

In addition, in the internal combustion engine according to the present disclosure, in a case where vehicle equipped with the internal combustion engine travels when the integrated value is less than the threshold and the operation state of the internal combustion engine is the target operation state, the controller may increase the in-cylinder injection ratio in accordance with the travel of the vehicle. In a case where the vehicle is traveling, an operation sound of the supply pump and the second injection valve is likely to be drowned out by a traveling sound of the vehicle. Therefore, even in a case where the in-cylinder injection ratio is increased in accordance with the vehicle starting to travel, it is difficult for the passenger to perceive an abnormal sound. Therefore, in a case where the integrated value is less than the threshold, by increasing the in-cylinder injection ratio in accordance with the vehicle starting to travel, it is possible to more reliably prevent accumulation of the deposit while reducing an abnormal sound perceived by the passenger.

In addition, in the internal combustion engine according to the present disclosure, increasing the in-cylinder injection ratio may include increasing the in-cylinder injection ratio in a stepwise manner. Accordingly, in a case where the radiator fan is stopped and the vehicle is parked, or the like, the in-cylinder injection ratio can be increased in a stepwise manner. As a result, since an operation sound of the supply pump and the second injection valve is increased in a stepwise manner, it is difficult for the passenger to perceive an abnormal sound.

Hereinafter, specific embodiments of the present disclosure will be described with reference to the drawings. Unless otherwise specified, the hardware configuration, module configuration, functional configuration, and the like described in the following embodiment are not intended to limit the technical scope of the disclosure.

### Embodiment

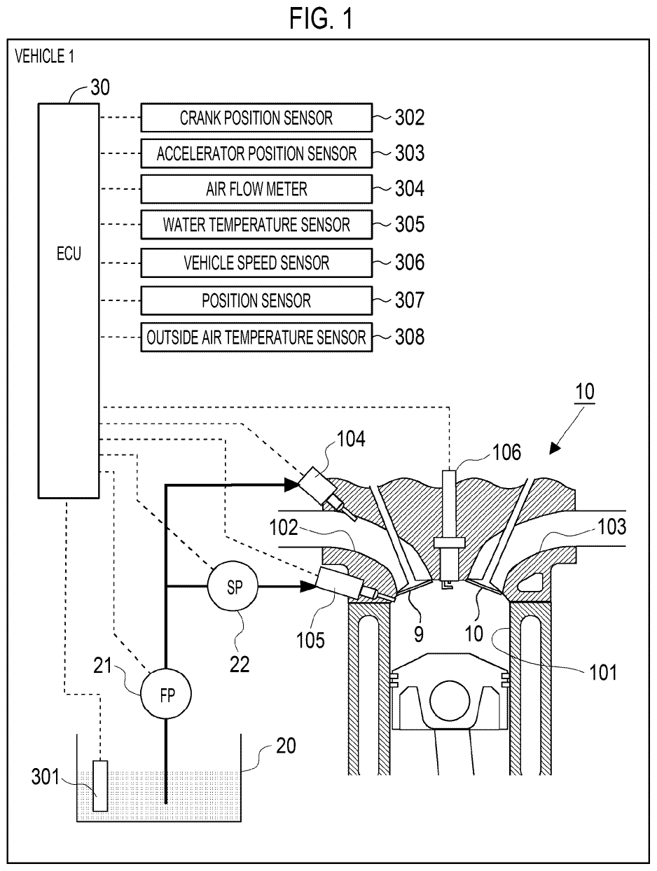

FIG. 1 is a diagram showing an example of a schematic configuration of a vehicle 1 to which the present disclosure is applied. The vehicle 1 shown in FIG. 1 is an automobile equipped with an internal combustion engine 10. The vehicle 1 may be an internal combustion engine vehicle using the internal combustion engine 10 as a power source, a hybrid electric vehicle (HEV) or a plug-in hybrid electric vehicle (PHEV) using a hybrid system of the internal combustion engine 10 and an electric motor as a power source, or a battery electric vehicle (BEV) using an electric motor that operates using power generated by the internal combustion engine 10 as a power source.

The internal combustion engine 10 is a spark-ignition type four-cycle engine (gasoline engine) that includes one or more cylinders 101 and uses gasoline as a fuel. The internal combustion engine 10 according to the present embodiment is configured to include an intake port 102, an exhaust port 103, a port injection valve 104, an in-cylinder injection valve 105, an ignition plug 106, an intake valve 107, and an exhaust valve 108. The intake port 102 is a passage through which air inhaled into the cylinder 101 flows. The exhaust port 103 is a passage through which a burnt gas discharged from the inside of the cylinder 101 flows. The port injection valve 104 is a fuel injection valve (injector) that injects a fuel into the intake port 102. The in-cylinder injection valve 105 is a fuel injection valve (injector) that injects the fuel into the cylinder 101. The ignition plug 106 is a component for igniting an air-fuel mixture generated inside the cylinder 101. The intake valve 107 is a poppet valve that opens and closes an opening end of the intake port 102 on a downstream side. The exhaust valve 108 is a poppet valve that opens and closes an opening end of the exhaust port 103 on an upstream side. In the present embodiment, the port injection valve 104 corresponds to a “first injection valve” according to the present disclosure, and the in-cylinder injection valve 105 corresponds to a “second injection valve” according to the present disclosure.

In addition, in the vehicle 1 according to the present embodiment, a fuel tank 20, a feed pump 21 (“FP” in FIG. 1), a supply pump 22 (“SP” in FIG. 1), and a fuel remaining amount sensor 301 are mounted. The fuel tank 20 is a tank that stores gasoline, which is a fuel of the internal combustion engine 10. The feed pump 21 is a pump that lifts a fuel stored in the fuel tank 20 and sends the lifted fuel to each of the port injection valve 104 and the supply pump 22. The supply pump 22 is a pump that pressurizes the fuel sent from the feed pump 21 and that sends the pressurized fuel to the in-cylinder injection valve 105. The fuel remaining amount sensor 301 is a sensor that detects the remaining amount of fuel stored in the fuel tank 20.

In addition, an electronic control unit (ECU) 30 for electrically controlling the internal combustion engine 10 and peripheral devices thereof is mounted in the vehicle 1 according to the present embodiment. The ECU 30 is a computer including a CPU, a ROM, a RAM, and an auxiliary storage device. In the ECU 30 according to the present embodiment, various sensors, such as a crank position sensor 302, an accelerator position sensor 303, an air flow meter 304, a water temperature sensor 305, a vehicle speed sensor 306, a position sensor 307, and an outside air temperature sensor 308, are connected in addition to the fuel remaining amount sensor 301, and signals thereof are input to the ECU 30. The crank position sensor 302 is a sensor that detects a rotational position of an output shaft (crankshaft) of the internal combustion engine 10. The accelerator position sensor 303 is a sensor that detects an operation amount of an accelerator pedal. The air flow meter 304 is a sensor that detects an inhaled air amount of the internal combustion engine 10. The water temperature sensor 305 is a sensor that detects a temperature of cooling water (coolant) circulating the internal combustion engine 10. The vehicle speed sensor 306 is a sensor that detects a traveling speed (for example, a rotation speed of a wheel) of the vehicle 1. The position sensor 307 is a device configured to acquire the position and current date and time of the vehicle 1 (for example, a receiver that acquires the position and current date and time of the vehicle 1 through wireless communication such as a GPS receiver or Wi-Fi (registered trademark)). The outside air temperature sensor 308 is a sensor that detects a temperature outside the vehicle.

In addition, the ECU 30 is electrically connected to the devices such as the port injection valve 104, the in-cylinder injection valve 105, the ignition plug 106, the feed pump 21, and the supply pump 22. The ECU 30 is configured to control the port injection valve 104, the in-cylinder injection valve 105, the ignition plug 106, the feed pump 21, the supply pump 22, and the like according to signals input from the sensors.

For example, the ECU 30 determines a fuel injection amount per cycle of each of the port injection valve 104 and the in-cylinder injection valve 105 according to an operation state of the internal combustion engine 10. Specifically, the ECU 30 first calculates an engine rotation speed Ne and an engine load rate KL for each cycle of the internal combustion engine 10. The engine rotation speed Ne described herein is a rotation speed of a crankshaft per unit time and is calculated according to a signal of the crank position sensor 302. The engine load rate KL is a ratio of a current inhaled air amount to a maximum value (an inhaled air amount at a full load) of the inhaled air amount corresponding to each engine rotation speed Ne, and is calculated according to a signal (inhaled air amount) of the air flow meter 304 and the engine rotation speed Ne.

The ECU 30 calculates an in-cylinder injection ratio (percentage) according to the calculated engine rotation speed Ne and engine load rate KL. The in-cylinder injection ratio described herein refers to a total fuel injection amount (a total amount of a fuel amount injected from the port injection valve 104 (port injection amount) and a fuel amount injected from the in-cylinder injection valve 105 (in-cylinder injection amount)) per cycle for each cylinder 101. For example, the ECU 30 calculates the in-cylinder injection ratio using a distribution map in which the engine rotation speed Ne and the engine load rate KL are used as parameters. The distribution map is stored in the ROM or the auxiliary storage device of the ECU 30 in advance. In the case, the ROM or the auxiliary storage device of the ECU 30 stores a plurality of distribution maps corresponding to a cooling water temperature, an outside air temperature, and the like.

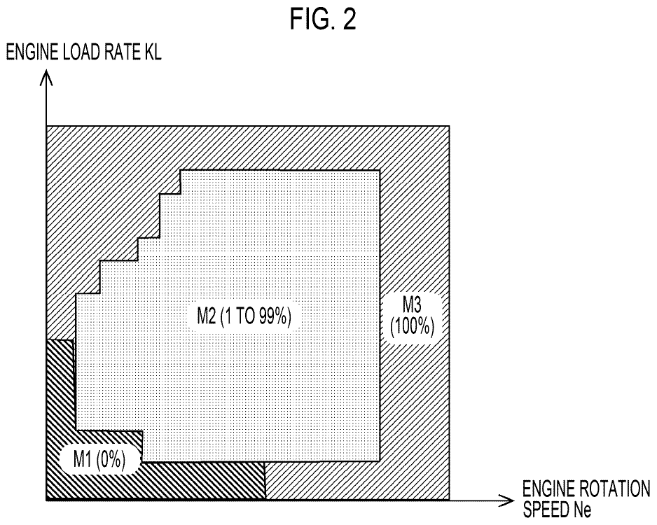

Here, FIG. 2 shows an example of the distribution map. The distribution map shown in FIG. 2 is a map for setting the in-cylinder injection ratio after completion of warming up of the internal combustion engine 10. In the example shown in FIG. 2, in a low-load low-speed operation region (region M1 in FIG. 2) where the engine rotation speed Ne and the engine load rate KL are relatively low, the in-cylinder injection ratio is set to 0%. In addition, in one or both of a high-speed operation region where the engine rotation speed Ne is relatively high and a high-load operation region (region M3 in FIG. 2) where the engine load rate KL is relatively high, the in-cylinder injection ratio is set to 100%. Furthermore, in a medium-load medium-speed operation region (region M2 in FIG. 2) other than the regions M1 and M3, the in-cylinder injection ratio is set according to the engine rotation speed Ne and the engine load rate KL within a range of 1% to 99%.

The ECU 30 calculates the in-cylinder injection amount and the port injection amount according to the in-cylinder injection ratio and the total fuel injection amount. That is, the ECU 30 calculates the in-cylinder injection amount by multiplying the total fuel injection amount by the in-cylinder injection ratio. The total fuel injection amount per cycle for each cylinder 101 may be, for example, calculated according to a signal (inhaled air amount) of the air flow meter 304 and a target air-fuel ratio (for example, a stoichiometric air-fuel ratio). In addition, the ECU 30 calculates the port injection amount by subtracting the in-cylinder injection ratio from the total fuel injection amount. The port injection amount may be calculated by calculating a port injection ratio from the in-cylinder injection ratio (100%—in-cylinder injection ratio) and multiplying the total fuel injection amount by the calculated port injection ratio.

The ECU 30 controls the supply pump 22 and the in-cylinder injection valve 105 according to the calculated in-cylinder injection amount, and controls the port injection valve 104 according to the calculated port injection amount. Accordingly, the fuel can be injected from each of the port injection valve 104 and the in-cylinder injection valve 105 at the in-cylinder injection ratio suitable for the operation state of the internal combustion engine 10.

Here, in a case where a time during which the internal combustion engine 10 is operated in an operation state (target operation state) where the operation state corresponds to the region M1 in FIG. 2 and the in-cylinder injection ratio is set to 0% after completion of warming up of the internal combustion engine 10 is long, there is a possibility that a deposit derived from the fuel injected from the port injection valve 104 is accumulated on the wall surface of the intake port 102, the back surface of the head portion of the intake valve 107, or the like, and a problem such as a failure in closing the intake valve 107 (a compression failure of the cylinder 101) is induced. Therefore, in the present disclosure, the ECU 30 executes processing (hereinafter, may be referred to as “deposit prevention processing”) for preventing one or both of accumulation of the deposit on the wall surface of the intake port 102 and the back surface of the head portion of the intake valve 107 and an excessive increase in the deposit accumulation amount, in accordance with an integrated value of time during which the internal combustion engine 10 has been operated in the target operation state becomes equal to or greater than a threshold. In the case, the integrated value may be an integrated value of time during which the internal combustion engine 10 has been continuously operated in the target operation state or may be an integrated value of time during which the internal combustion engine 10 has been intermittently operated in the target operation state.

In the present embodiment, the ECU 30 corresponds to a “controller” according to the present disclosure.

### Deposit Prevention Processing

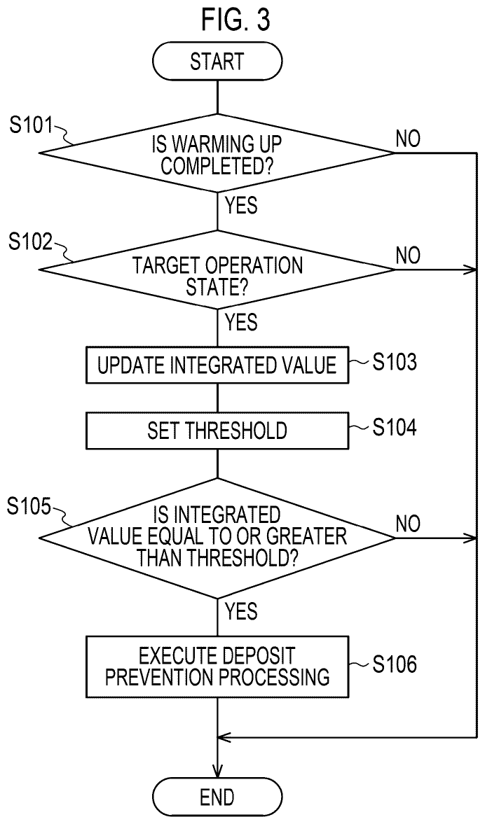

Here, the deposit prevention processing in the present embodiment will be described with reference to FIG. 3. FIG. 3 is a flowchart showing an example of a processing routine executed by the ECU 30 according to the present embodiment. The processing routine in FIG. 3 is repeatedly executed during the operation of the internal combustion engine 10 at an interval that is predetermined (for example, for each cycle).

In the processing routine in FIG. 3, the ECU 30 determines whether the internal combustion engine 10 is in a warmed-up state (S101). For example, the ECU 30 determines whether a cooling water temperature (coolant temperature) detected by the water temperature sensor 305 is equal to or higher than a temperature that is predetermined (for example, about 60° C. to 80° C.). In a case where the cooling water temperature is lower than the temperature that is predetermined, the ECU 30 determines that the internal combustion engine 10 is in a state before completion of warming up (negative determination in S101). In addition, in a case where the cooling water temperature is equal to or higher than the temperature that is predetermined, the ECU 30 determines that the internal combustion engine 10 is in a warmed-up state (positive determination in S101).

In a case where a negative determination is made in S101, the execution of the present processing routine is ended. In the case, the ECU 30 may determine the in-cylinder injection ratio according to a map for setting the in-cylinder injection ratio before completion of warming up of the internal combustion engine 10, and calculate the in-cylinder injection amount and the port injection amount according to the determined in-cylinder injection ratio. In addition, in a case where a positive determination is made in S101, the ECU 30 executes processing of S102.

In S102, the ECU 30 determines whether a current operation state of the internal combustion engine 10 corresponds to the target operation state. As described above, the target operation state is an operation state that belongs to the region M1 in FIG. 2 and in which the in-cylinder injection ratio is set to 0%. In the determination, first, the ECU 30 calculates the engine rotation speed Ne and the engine load rate KL according to the signals of the crank position sensor 302 and the air flow meter 304. Subsequently, the ECU 30 determines whether the operation state specified by the calculated engine rotation speed Ne and the engine load rate KL belongs to region M1 by accessing the distribution map in FIG. 2 using the engine rotation speed Ne and the engine load rate KL as parameters. In a case where it is determined that the operation state of the internal combustion engine 10 belongs to the region M1, the ECU 30 determines whether the in-cylinder injection ratio is set to 0%. That is, the ECU 30 determines whether the deposit prevention processing described later is in a state where it is not being executed.

In one or both of a case where the operation state of the internal combustion engine 10 does not belong to the region M1 and a case where the in-cylinder injection ratio is not set to 0% (negative determination in S102), the ECU 30 ends the execution of the present processing routine. In the case, the ECU 30 may set the in-cylinder injection ratio according to the distribution map in FIG. 2 and calculate the in-cylinder injection amount and the port injection amount according to the set in-cylinder injection ratio. In addition, in a case where the operation state of the internal combustion engine 10 belongs to the region M1 and the in-cylinder injection ratio is set to 0% (positive determination in S102), the ECU 30 executes processing of S103.

In S103, the ECU 30 updates the integrated value of time during which the internal combustion engine 10 has been operated in the target operation state. For example, the ECU 30 may add a required time for one cycle (a time required for the internal combustion engine 10 to perform operation for one cycle) to a previous value of the integrated value. In the case, the required time for one cycle may be calculated according to the engine rotation speed Ne. When the processing of S103 is completed, the ECU 30 executes the processing of S104.

In S104, the ECU 30 sets the threshold. The threshold described herein may be a time shorter than a time expected to be required until a fuel adhering to the wall surface of the intake port 102 or the back surface of the head portion of the intake valve 107 (adhesive fuel) changes to a deposit. In another example, the threshold may be a time during which an accumulation amount of deposit derived from the adhesive fuel is not expected to exceed an upper limit value. In the case, the upper limit value may be, for example, a minimum value of a deposit accumulation amount at which, when the deposit accumulation amount exceeds the upper limit value, an air amount satisfying a required torque cannot flow into the cylinder. In another example, the upper limit value may be a minimum value of a deposit accumulation amount at which the deposit is considered to easily peeled off from an intake port wall surface or the back surface of the head portion of the intake valve. The threshold as described above may be obtained in advance through one or both of experiments and simulations.

The time expected to be required until the adhesive fuel changes to a deposit and the time during which the amount of deposit derived from the adhesive fuel is not expected to exceed the upper limit value may change according to one or both of a fuel property and an outside air temperature. The fuel property may change depending on one or both of an area and a time (season) at which the fuel is refueled. Therefore, in the present embodiment, the threshold is determined based on an area where fuel was lastly refueled for the vehicle 1 (hereinafter referred to as “refueling area”), a time when fuel was lastly refueled for the vehicle 1 (hereinafter referred to as “refueling time”), and a current outside air temperature. In the case, a map or a table capable of deriving the threshold using the refueling area, the refueling time, and the outside air temperature as parameters may be stored in the ROM or the auxiliary storage device of the ECU 30 in advance. Then, the ECU 30 may access the map or the table using the refueling area, the refueling time, and the current outside air temperature as parameters to derive a threshold suitable for the parameters.

The refueling area and the refueling time described above can be specified according to, for example, signals of the fuel remaining amount sensor 301 and the position sensor 307. That is, the ECU 30 can detect refueling based on an increase in a fuel remaining amount (the remaining amount of fuel stored in the fuel tank 20) detected by the fuel remaining amount sensor 301. Then, the ECU 30 can specify the refueling area and the refueling time by acquiring the position of the vehicle 1 and the date and time at the point in time through the position sensor 307 in accordance with detection of refueling of the fuel. The auxiliary storage device of the ECU 30 may store the refueling area and the refueling time specified in such a manner. The refueling area and the refueling time stored in the auxiliary storage device may be updated (overwritten) each time refueling is performed. A method of determining the refueling area and the refueling time is not limited to the method, and may be determined through other known methods. In addition, the current outside air temperature can be acquired through the outside air temperature sensor 308.

The threshold may be determined according to at least one of the refueling area, the refueling time, or the outside air temperature. In the case, the map or the table in which a correlation between at least one of the refueling area, the refueling time, or the outside air temperature and the threshold is defined may be stored in the ROM or the auxiliary storage device of the ECU 30 in advance.

In addition, the fuel property may be determined according to a correction amount used for feedback control of the fuel injection amount. For example, it can be estimated that the larger the correction amount to a fuel injection amount increase side is, the more likely the property of the fuel stored in the fuel tank 20 is to cause the deposit to accumulate. Therefore, a map or a table using the correction amount used for feedback control of the fuel injection amount and the outside air temperature as parameters may be stored in the ROM or the auxiliary storage device of the ECU 30 in advance. In the case, the ECU 30 may access the map or the table using the current correction amount and the current outside air temperature as parameters to derive a threshold suitable for the parameters.

Here, the description will return to FIG. 3. When the processing of S104 is completed, the ECU 30 executes the processing of S105. In S105, the ECU 30 determines whether the integrated value updated in S103 is equal to or greater than the threshold set in S104. In a case where the integrated value updated in S103 is less than the threshold set in S104 (negative determination in S105), the ECU 30 ends the execution of the present processing routine. In the case, the ECU 30 may determine the in-cylinder injection ratio according to the distribution map in FIG. 2 (in-cylinder injection ratio=0%), and determine the in-cylinder injection amount and the port injection amount according to the determined in-cylinder injection ratio. In addition, in a case where the integrated value updated in S103 is equal to or greater than the threshold set in S104 (positive determination in S105), the ECU 30 executes the processing of S106.

In S106, the ECU 30 executes the deposit prevention processing. The deposit prevention processing is processing of forcibly increasing the in-cylinder injection ratio in the region M1 in FIG. 2 from 0% to a ratio that is predetermined of equal to or greater than 1%. Here, in a case where a transition is made from a state where the in-cylinder injection ratio is 0% (a state where the in-cylinder injection valve 105 does not perform fuel injection) to a state where the in-cylinders injection ratio is equal to or greater than 1% (a state where the in-cylinder injection valve 105 performs fuel injection), an operation sound generated by a pressurization operation of the supply pump 22 and an opening and closing operation of the in-cylinder injection valve 105 occurs. Such an operation sound tends to be larger than an operation sound of the port injection valve 104. Therefore, when the operation state of the internal combustion engine 10 belongs to the region M1 in FIG. 2 and the vehicle 1 is in a parked state, and the in-cylinder injection ratio is immediately increased from 0% to a ratio that is predetermined, there is a possibility that a passenger of the vehicle 1 perceives an abnormal sound. Therefore, the ECU 30 may immediately increase the in-cylinder injection ratio from 0% to a ratio that is predetermined when the vehicle 1 is in a traveling state, and may increase the in-cylinder injection ratio from 0% to a ratio that is predetermined in a stepwise manner when the vehicle 1 is in a parked state. The ratio that is predetermined described herein is suitably 100% but may be less than 100%. That is, the ratio that is predetermined may be appropriately changed according to exhaust gas control performance, a fuel consumption rate, and the like.

When the processing of S106 is completed, the ECU 30 ends the execution of the present processing routine.

### Action and Effect of Embodiment

In the present embodiment, in a case where the integrated value of time during which the internal combustion engine 10 has been operated in the target operation state is equal to or greater than the threshold, the deposit prevention processing (processing of forcibly increasing the in-cylinder injection ratio from 0% to a ratio that is predetermined) is executed. Accordingly, it is possible to prevent one or both of the generation of a deposit derived from the fuel injected from the port injection valve 104 on the wall surface of the intake port 102, the back surface of the head portion of the intake valve 107, or the like, and an excessive accumulation amount of the deposit. In addition, in a case where the integrated value is less than the threshold, the deposit prevention processing is not executed and the in-cylinder injection ratio is set to 0%. Therefore, it is possible to minimize a frequency at which the deposit prevention processing is executed. Accordingly, it is possible to reduce the opportunity for a passenger of the vehicle 1 to perceive an abnormal sound due to the execution of the deposit prevention processing. Furthermore, in a case where the vehicle 1 is in a parked state, the operation sound of the supply pump 22 and the in-cylinder injection valve 105 increases in a stepwise manner as the in-cylinder injection ratio is increased in a stepwise manner. Therefore, it is possible to reduce the likelihood of a passenger perceiving an abnormal sound.

In addition, in the present disclosure, the threshold is set according to a fuel property and an outside air temperature. Accordingly, it is possible to more reliably prevent one or both of the generation of a deposit on the intake port 102 or the back surface of the head portion of the intake valve 107 and an excessive increase in the accumulation amount while reducing the opportunity for the passenger to perceive an abnormal sound as much as possible.

### Modification 1

In the embodiment, an example in which the deposit prevention processing is not executed until the integrated value of time during which the internal combustion engine 10 is operated in the target operation state becomes equal to or greater than the threshold has been described. However, even in a case where the integrated value is less than the threshold, the deposit prevention processing may be executed in accordance with the operation of the radiator fan 309.

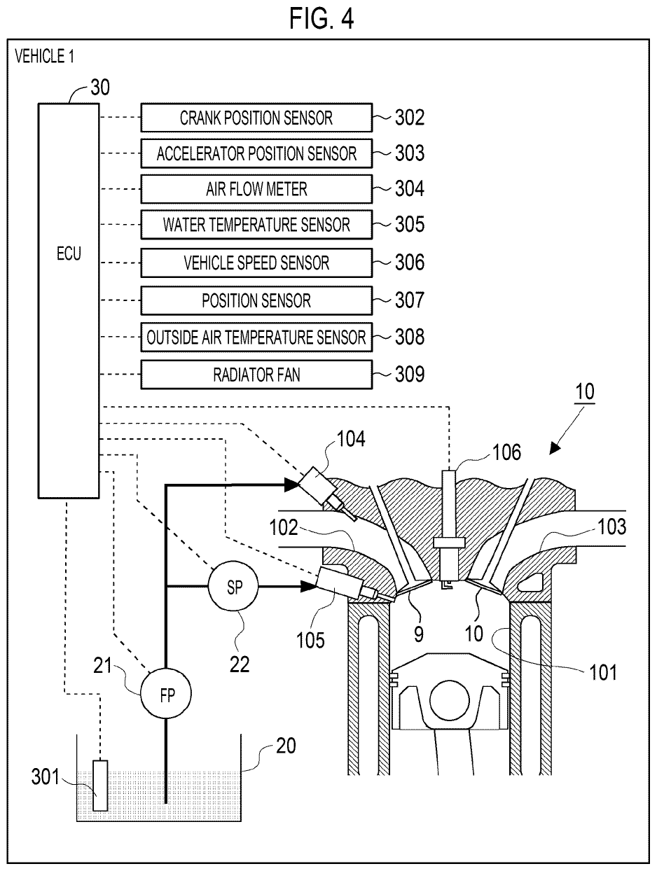

FIG. 4 is a diagram showing an example of a schematic configuration of the vehicle 1 according to Modification 1. In Modification 1, the vehicle 1 is equipped with the radiator fan 309 in addition to the components exemplified in the embodiment. The radiator fan 309 is an electric fan device for cooling a radiator that performs heat exchange between cooling water of the internal combustion engine 10 and the atmosphere. For example, the radiator fan 309 is operated by the ECU 30 in accordance with the cooling water temperature detected by the water temperature sensor 305 becomes equal to or higher than an operation temperature that is predetermined (for example, about 100° C.). An operation sound of the radiator fan 309 tends to be larger than the operation sounds of the supply pump 22 and the in-cylinder injection valve 105. Therefore, even in a case where the deposit prevention processing is executed during the operation of the radiator fan 309, it is difficult for the passenger of the vehicle 1 to perceive an abnormal sound caused by the operation sound of the supply pump 22 and the in-cylinder injection valve 105. Therefore, in Modification 1, in a case where the radiator fan 309 operates when the internal combustion engine 10 is being operated in the target operation state, the deposit prevention processing is executed regardless of whether the integrated value is equal to or greater than the threshold.

### Deposit Prevention Processing

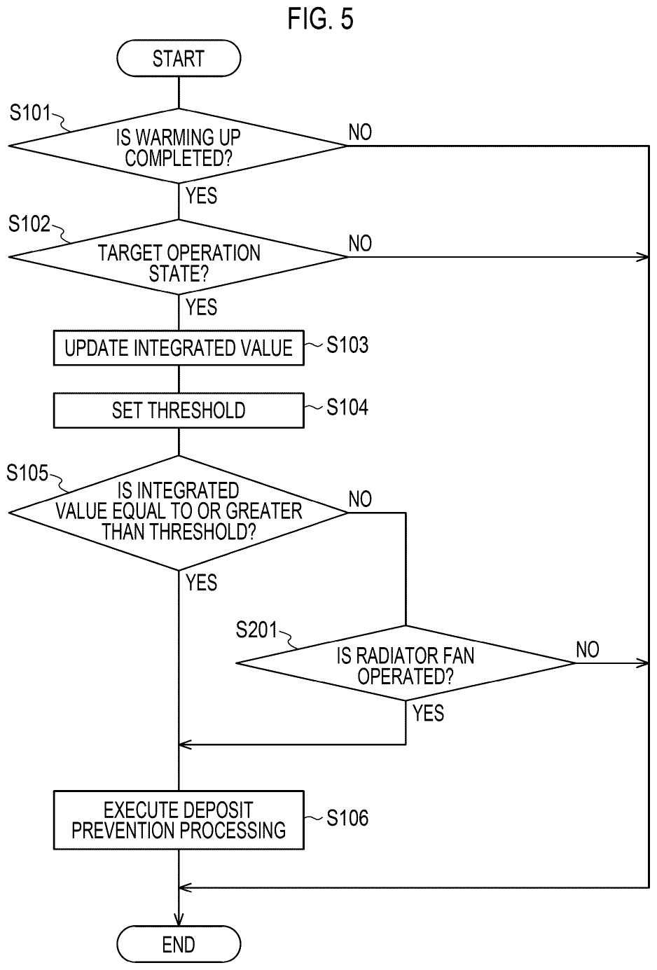

FIG. 5 is a flowchart showing an example of a processing routine executed by the ECU 30 according to Modification 1. The processing routine in FIG. 5 is repeatedly executed during the operation of the internal combustion engine 10 at an interval that is predetermined (for example, for each cycle) as in the processing routine in FIG. 3 described above. In addition, among the processing (step) in FIG. 5, processing similar to the processing (step) in FIG. 3 described above is denoted by the same reference numerals as the reference numerals in FIG. 3 and the description thereof will be omitted.

In the processing routine in FIG. 5, in a case where a negative determination is made in S105 (in a case where the integrated value is less than the threshold), the processing of S201 is executed. In S201, the ECU 30 determines whether the radiator fan 309 is in an operation state. In a case where the radiator fan 309 is not operating (negative determination in S201), the ECU 30 ends the execution of the processing routine in FIG. 5. In the case, the ECU 30 may set the in-cylinder injection ratio according to the distribution map in FIG. 2 and calculate the in-cylinder injection amount and the port injection amount according to the set in-cylinder injection ratio. In addition, in a case where the radiator fan 309 is operating (positive determination in S201), the ECU 30 executes the processing of S106. That is, the ECU 30 executes the deposit prevention processing.

### Action and Effect of Modification 1

In Modification 1 described above, in a case where the radiator fan 309 operates when the internal combustion engine 10 is being operated in the target operation state, the ECU 30 executes the deposit prevention processing regardless of whether the integrated value is equal to or greater than the threshold. When the radiator fan 309 is operating, an operation sound of the supply pump 22 and the in-cylinder injection valve 105 is likely to be drowned out by an operation sound of the radiator fan 309. Therefore, the deposit prevention processing can be executed while suppressing the perception of an abnormal sound by the passenger of the vehicle 1. Furthermore, since the deposit prevention processing can be executed before the integrated value becomes equal to or greater than the threshold, it is possible to more reliably prevent one or both of the generation of a deposit derived from the fuel injected from the port injection valve 104 on the wall surface of the intake port 102, the back surface of the head portion of the intake valve 107, or the like, and an excessive accumulation amount of the deposit.

### Modification 2

In the embodiment, an example in which the deposit prevention processing is not executed until the integrated value of time during which the internal combustion engine 10 is operated in the target operation state becomes equal to or greater than the threshold has been described. However, even in a case where the integrated value is less than the threshold, the deposit prevention processing may be executed in accordance with the traveling of the vehicle 1.

During the traveling of the vehicle 1, an operation sound of the supply pump 22 and the in-cylinder injection valve 105 is likely to be drowned out by a traveling sound of the vehicle 1. Therefore, in Modification 2, in a case where the vehicle 1 starts traveling when the internal combustion engine 10 is being operated in the target operation state, the deposit prevention processing is executed regardless of whether the integrated value is equal to or greater than the threshold.

### Deposit Prevention Processing

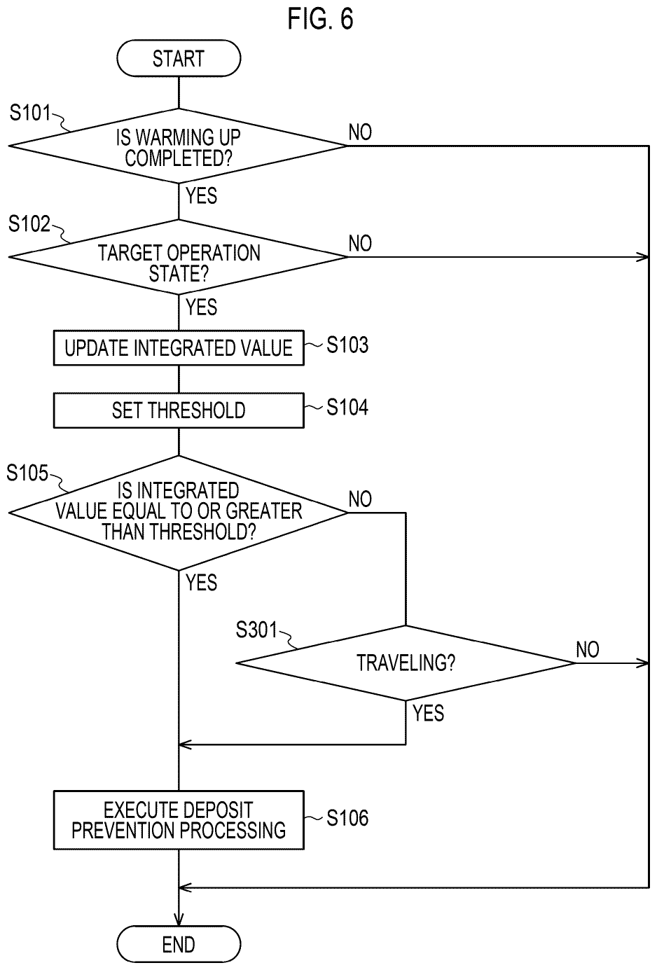

FIG. 6 is a flowchart showing an example of a processing routine executed by the ECU 30 according to Modification 2. The processing routine in FIG. 6 is repeatedly executed during the operation of the internal combustion engine 10 at an interval that is predetermined (for example, for each cycle) as in the processing routine in FIG. 3 described above. In addition, among the processing (step) in FIG. 6, processing similar to the processing (step) in FIG. 3 described above is denoted by the same reference numerals as the reference numerals in FIG. 3 and the description thereof will be omitted.

In the processing routine in FIG. 6, in a case where a negative determination is made in S105 (in a case where the integrated value is less than the threshold), the processing of S301 is executed. In S301, the ECU 30 determines whether the vehicle 1 is in a traveling state. For example, the ECU 30 may determine whether a traveling speed detected by the vehicle speed sensor 306 is larger than 0 km/h. In a case where the traveling speed detected by the vehicle speed sensor 306 is 0 km/h (negative determination in S301), the ECU 30 ends the execution of the processing routine in FIG. 6. In the case, the ECU 30 may set the in-cylinder injection ratio according to the distribution map in FIG. 2 and calculate the in-cylinder injection amount and the port injection amount according to the set in-cylinder injection ratio. Furthermore, when the traveling speed detected by the vehicle speed sensor 306 is greater than 0 km/h (positive determination in S 301), the ECU 30 executes processing in S106. That is, the ECU 30 executes the deposit prevention processing.

### Action and Effect of Modification 2

In Modification 2 described above, in a case where the vehicle 1 starts traveling when the internal combustion engine 10 is being operated in the target operation state, the ECU 30 executes the deposit prevention processing regardless of whether the integrated value is equal to or greater than the threshold. During the traveling of the vehicle 1, an operation sound of the supply pump 22 and the in-cylinder injection valve 105 is likely to be drowned out by a traveling sound of the vehicle 1. Therefore, the deposit prevention processing can be executed while suppressing the perception of an abnormal sound by the passenger of the vehicle 1. Furthermore, since the deposit prevention processing can be executed before the integrated value becomes equal to or greater than the threshold, it is possible to more reliably prevent one or both of the generation of a deposit derived from the fuel injected from the port injection valve 104 on the wall surface of the intake port 102, the back surface of the head portion of the intake valve 107, or the like, and an excessive accumulation amount of the deposit.

### Others

The embodiment and the modifications described above are merely examples, and the present disclosure can be appropriately changed and implemented without departing from the gist thereof. For example, the embodiment and the modifications described above can be implemented in combination with each other without any technical contradiction.

What is claimed is:

1. An internal combustion engine comprising:
a first injection valve configured to inject a fuel into an intake port of the internal combustion engine;
a second injection valve configured to inject a fuel into a cylinder of the internal combustion engine; and
a controller configured to control an in-cylinder injection ratio that is a ratio of an in-cylinder injection amount to a total amount of a port injection amount and the in-cylinder injection amount, the port injection amount being a fuel injection amount of the first injection valve and the in-cylinder injection amount being a fuel injection amount of the second injection valve,
wherein the controller is configured to increase the in-cylinder injection ratio in response to an integrated value of time during which the internal combustion engine has been operated in a target operation state reaching or exceeding a threshold, the target operation state being an operation state in which the in-cylinder injection ratio is 0% in a low-load low-speed operation region that is predetermined.

2. The internal combustion engine according to claim 1, wherein the threshold is set according to at least one of an area where a vehicle equipped with the internal combustion engine has been lastly refueled, a time when the vehicle has been lastly refueled, or an outside air temperature.

3. The internal combustion engine according to claim 1, wherein the controller is configured to, in a case where a radiator fan is operated when the integrated value is less than the threshold and an operation state of the internal combustion engine is the target operation state, increase the in-cylinder injection ratio in response to an operation of the radiator fan.

4. The internal combustion engine according to claim 1, wherein the controller is configured to, in a case where a vehicle equipped with the internal combustion engine travels when the integrated value is less than the threshold and an operation state of the internal combustion engine is the target operation state, increase the in-cylinder injection ratio in response to traveling of the vehicle.

5. The internal combustion engine according to claim 1, wherein increasing the in-cylinder injection ratio includes increasing the in-cylinder injection ratio in a stepwise manner.
